(19) United States
(12) Patent Application Publication
(10) Pub. No.: US 2026/0339976 A1
(43) Pub. Date: Oct. 29, 2026

(54) INFORMATION SYNCHRONIZATION PROCESSING METHOD, SYSTEM AND APPARATUS, AND ELECTRONIC DEVICE AND STORAGE MEDIUM

(71) Applicant: Beijing Zitiao Network Technology Co., Ltd., Beijing (CN)

(72) Inventors: Bo LI, Beijing (CN); Jiayi ZHANG, Beijing (CN); Lu WANG, Beijing (CN); Weilun GUO, Beijing (CN); Zhendong JIANG, Beijing (CN)

(21) Appl. No.: 19/123,382

(22) PCT Filed: Sep. 21, 2023
(86) PCT No.: PCT/CN2023/120380

§ 371 Date: Apr. 22, 2025

(30) Foreign Application Priority Data
Oct. 31, 2022 (CN) 202211351902.0

(51) Int. Cl. G06F 16/27

(52) U.S. Cl. CPC G06F 16/27

(57) ABSTRACT

Provided in the present disclosure are an information synchronization processing method, system and apparatus, and an electronic device and a storage medium. The method includes: receiving a first service synchronization request and determining a serving module from which the first service synchronization request comes; if the first service synchronization request comes from an online document serving module, determining a service synchronization type of the first service synchronization request, and synchronizing first service information in a first service information serving module on the basis of the determined service synchronization type; and if the first service synchronization request comes from the first service information serving module, synchronizing records about the first service information in a target online document in the online document serving module on the basis of the first service synchronization request.

### CROSS-REFERENCE TO RELATED APPLICATIONS

The present disclosure claims the priority to the Chinese patent application No. 202211351902.0 entitled “INFORMATION SYNCHRONIZATION PROCESSING METHOD, SYSTEM AND APPARATUS, AND ELECTRONIC DEVICE AND STORAGE MEDIUM” filed on Oct. 31, 2022, the disclosure of which is incorporated by reference herein in its entirety.

### TECHNICAL FIELD

The present disclosure relates to the field of computer technology, and in particular, to an information synchronization processing method, system and apparatus, and an electronic device and a storage medium.

### BACKGROUND

In team collaboration, business information needs to be created, distributed, managed, updated, maintained, and the like in time. Business information management solutions provided in the related art have the problem of low efficiency in business information processing.

### SUMMARY

The “SUMMARY” is provided to introduce concepts in a simplified form, which will be described in detail below in the following “DETAILED DESCRIPTION”. The “SUMMARY” is not intended to identify key features or essential features of the claimed technical solutions, nor is it intended to limit the scope of the claimed technical solutions.

In a first aspect, according to one or more embodiments of the present disclosure, there is provided an information synchronization processing method, comprising:
receiving a first business synchronization request;
determining a serving module from which the first business synchronization request comes; and
at least one of the following synchronization steps:
   if the first business synchronization request comes from an online document serving module, determining a business synchronization type of the first business synchronization request, and synchronizing first business information in a first business information serving module on the basis of the determined business synchronization type; or
   if the first business synchronization request comes from the first business information serving module, synchronizing a record about the first business information in a target online document in the online document serving module on the basis of the first business synchronization request.

In a second aspect, according to one or more embodiments of the present disclosure, there is provided an information synchronization processing system, comprising:
an online document serving module configured to, in response to a first preset operation of a user in a target online document, send a first business synchronization request to a business synchronization serving module;
a first business information serving module configured to, in response to monitoring a synchronization event of first business information, send the first business synchronization request to the business synchronization serving module; and
the business synchronization serving module configured to, in response to receiving the first business synchronization request, perform the following operations: determining a serving module from which the first business synchronization request comes; and at least one of the following synchronization operations: if the first business synchronization request comes from the online document serving module, determining a business synchronization type of the first business synchronization request, and synchronizing the first business information in the first business information serving module on the basis of the determined business synchronization type; or, if the first business synchronization request comes from the first business information serving module, synchronizing a record about the first business information in the target online document in the online document serving module on the basis of the first business synchronization request.

In a third aspect, according to one or more embodiments of the present disclosure, there is provided an information synchronization processing apparatus, comprising:
a request receiving unit configured to receive a first business synchronization request;
a request determination unit configured to determine a serving module from which the first business synchronization request comes; and
a business synchronization unit configured to perform at least one of the following synchronization operations: if the first business synchronization request comes from an online document serving module, determining a business synchronization type of the first business synchronization request, and synchronizing first business information in a first business information serving module on the basis of the determined business synchronization type, or if the first business synchronization request comes from the first business information serving module, synchronizing a record about the first business information in a target online document in the online document serving module on the basis of the first business synchronization request.

In a fourth aspect, according to one or more embodiments of the present disclosure, there is provided an electronic device, comprising: at least one memory and at least one processor, wherein the memory is configured to store program codes, and the processor is configured to call the program codes stored in the memory to cause the electronic device to perform the information synchronization processing method according to one or more embodiments of the present disclosure.

In a fifth aspect, according to one or more embodiments of the present disclosure, there is provided a non-transitory computer storage medium having stored thereon program codes which, when executed by a computer device, cause the computer device to perform the information synchronization processing method according to one or more embodiments of the present disclosure.

In a sixth aspect, according to one or more embodiments of the present disclosure, there is provided a computer program which, when executed by a processor, implements the information synchronization processing method according to one or more embodiments of the present disclosure.

### BRIEF DESCRIPTION OF THE DRAWINGS

The above and other features, advantages, and aspects of embodiments of the present disclosure will become more apparent by combining the accompanying drawings and referring to the following DETAILED DESCRIPTION. Throughout the drawings, the same or similar reference numbers refer to the same or similar elements. It should be understood that the drawings are schematic and that components and elements are not necessarily drawn to scale.

FIG. 1 is a flow diagram of an information synchronization processing method according to an embodiment of the present disclosure;

FIG. 2 is a schematic diagram of a display page for a target online document according to an embodiment of the present disclosure;

FIG. 3 is a schematic diagram of a task information display page according to an embodiment of the present disclosure;

FIG. 4 is a schematic diagram of a business abstraction relationship between an online table and first business information according to an embodiment of the present disclosure;

FIG. 5 is a flow diagram of an information synchronization processing method according to another embodiment of the present disclosure;

FIG. 6 is a flow diagram of a method of initializing a target online document according to an embodiment of the present disclosure; and

FIG. 7 is a schematic structural diagram of an electronic device according to an embodiment of the present disclosure.

### DETAILED DESCRIPTION

The embodiments of the present disclosure will be described in more detail below with reference to the accompanying drawings. While certain embodiments of the present disclosure are shown in the drawings, it should be understood that the present disclosure may be implemented in various forms and should not be construed as limited to the embodiments set forth herein, which are provided for a more complete and thorough understanding of the present disclosure rather. It should be understood that the drawings and embodiments of the present disclosure are for exemplary purposes only and are not intended to limit the scope of protection of the present disclosure.

It should be understood that steps recited in the embodiment of the present disclosure may be performed in a different order, and/or performed in parallel. Furthermore, the embodiment may include an additional step and/or omit performing the illustrated steps. The scope of the present disclosure is not limited in this respect.

The term “include” and variations thereof used herein are intended to be open-minded, i.e., “including but not limited to”. The term “based on” is “at least partially based on”. The term “one embodiment” means “at least one embodiment”; the term “another embodiment” means “at least one other embodiment”; and the term “some embodiments” means “at least some embodiments”. The term “in response to” and related terms refer to one signal or event being affected to some extent by another signal or event, but not necessarily completely or directly. If an event x occurs “in response to” an event y, x may respond directly or indirectly to y. For example, occurrence of y may ultimately result in occurrence of x, but there may be another intermediate event and/or condition. In another case, y may not necessarily result in occurrence of x, and x may still occur even if y has not yet occurred. Furthermore, the term “in response to” may also mean “at least partially in response to”.

The term “determine” broadly encompasses a wide variety of actions that can include acquiring, calculating, computing, processing, deriving, investigating, searching (e.g., searching in a table, a database or another data structure), ascertaining and the like, can also include receiving (e.g., receiving information), accessing (e.g., accessing data in a memory) and the like, can also include receiving, generating, creating, establishing and the like, as well as analyzing, choosing, selecting and the like. Related definitions for other terms will be given in the following description.

It should be noted that concepts “first”, “second”, and the like mentioned in the present disclosure are only used for distinguishing different devices, modules or units, and are not used for limiting the order or interdependence of functions performed by the devices, modules or units.

It should be noted that the modification of “a” or “a plurality” mentioned in the present disclosure is intended to be illustrative rather than restrictive, and that those skilled in the art should appreciate that it should be understood as “one or more” unless otherwise explicitly stated in the context.

For the purposes of this disclosure, the phrase “A and/or B” means (A), (B), or (A and B).

The names of messages or information exchanged between a plurality of devices in the embodiments of the present disclosure are for illustrative purposes only, and are not intended to limit the scope of the messages or information.

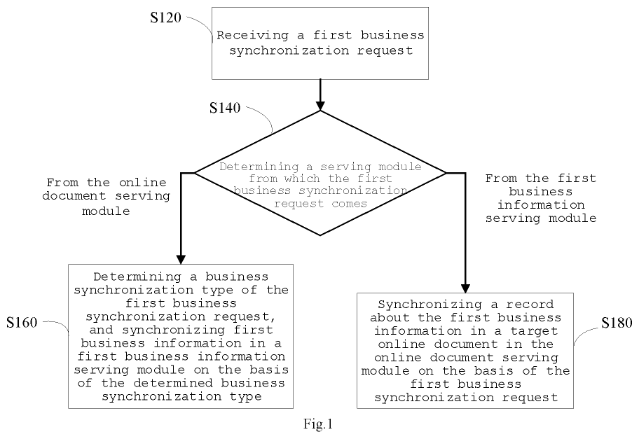

According to one or more embodiments of the present disclosure, when a first business synchronization request comes from an online document serving module, a business synchronization type of the first business synchronization request is determined, and first business information in a first business information serving module is synchronized on the basis of the determined business synchronization type, and when the first business synchronization request comes from the first business information serving module, a record about the first business information in a target online document in the online document serving module is synchronized on the basis of the first business synchronization request, thereby achieving bidirectional communication between the online document serving module and the first business information serving module, such that the first business information can be synchronized between the online document serving module and the first business information serving module, and a user can perform visualization management on the first business information using an online document, improving the processing efficiency of the first business information. Referring to FIG. 1, FIG. 1 illustrates an information synchronization processing method according to an embodiment of the present disclosure, which comprises steps S120 to S180.
Step S120: receiving a first business synchronization request.

In some embodiments, the first business synchronization request is used for synchronizing first business information in another serving module other than a serving module that sends the first business synchronization request, and the first business synchronization request may include but is not limited to, for example: a request for creating, updating, or deleting the first business information, a request for creating, updating, or deleting associated information of the first business information, or a request for updating a preset state of the first business information.

In some embodiments, the first business information may be task information or an instant messaging (IM) message.

An online document may be a document provided for online editing by a user and collaboration between a plurality of users, and stored in real-time in a cloud, which can be subjected to document display by for example a Hyper Text markup language (HTML) page, and synchronize content edited by the users depending on communication between the client and the server, and types of the online document may be an online Word document, an online Excel document, an online PPT document, and an online drawing document.

The online document serving module may be a module for providing an online document service to the user, and may be integrated in a client or a server, but this disclosure is not limited thereto. In a specific implementation, the online document serving module (e.g., the client) may provide the function of online document, and on the basis of a click operation of a user, the online document serving module loads, by an interface provided by a browser, a page for the online document by calling a browser kernel, such that on the basis of the loaded page, the user may create and edit the online document; of course, the user may share the online document through the online document serving module; in some other embodiments, the online document serving module has therein integrated the browser kernel by calling which a page for an online document is displayed in the client; in some other embodiments, the online document serving module is an online document client by running which a page for an online document is loaded and displayed; in some other embodiments, there is an applet corresponding to the function of online document, and the client downloads and runs source codes of the online document applet, to load and display a page for an online document.

The first business information serving module may be a module for serving the user with creation, distribution, management (e.g., update, deletion, etc.), etc. of the first business information, and may be integrated in the client or the server, but this disclosure is not limited thereto. In a specific implementation, the first business information serving module may be an instant messaging service, by which the user may create, distribute, and manage (e.g., update, delete, etc.) the first business information, but this disclosure is not limited thereto.
Step S140: determining a serving module from which the first business synchronization request comes.

In some embodiments, a party that sends the first business synchronization request may be the online document serving module or the first business information serving module, and accordingly, a party where the first business information is synchronized may be the first business information serving module or the online document serving module.
Step S160: if the first business synchronization request comes from an online document serving module, determining a business synchronization type of the first business synchronization request, and synchronizing first business information in the first business information serving module on the basis of the determined business synchronization type.

In some embodiments, if the type of the first business synchronization request is one for creating the first business information, the first business information may be created in a first business information service on the basis of the first business synchronization request; if the type of the first business synchronization request is one for deleting the first business information, the first business information may be deleted in the first business information service on the basis of the first business synchronization request; if the type of the first business synchronization request is one for updating the first business information, the first business information may be updated in the first business information service on the basis of the first business synchronization request; if the type of the first business synchronization request is one for creating associated information of the first business information, the associated information of the first business information may be created in the first business information service on the basis of the first business synchronization request; if the type of the first business synchronization request is one for deleting the associated information of the first business information, the associated information of the first business information may be deleted in the first business information service on the basis of the first business synchronization request; if the type of the first business synchronization request is one for updating the associated information of the first business information, the associated information of the first business information may be updated in the first business information service on the basis of the first business synchronization request; and if the type of the first business synchronization request is one for updating a preset state of the first business information, the preset state of the first business information may be updated in the first business information service on the basis of the first business synchronization request.

In a specific implementation, the first business information in the first business information serving module may be synchronized by calling a corresponding preset interface (Application Programming Interface, API) on the basis of the type of the first service request. Exemplarily, the preset interface includes an interface for creating, deleting, or updating the first business information, an interface for creating, deleting, or updating associated information of the first business information, or an interface for updating a preset state of the first business information.

In some embodiments, the associated information comprises comment information.

In some embodiments, if the first business information is task information, the preset state of the first business information includes a state of whether a task is completed.
Step S180: if the first business synchronization request comes from the first business information serving module, synchronizing a record about the first business information in a target online document in the online document serving module on the basis of the first business synchronization request.

In some embodiments, the first business synchronization request is triggered by the first business information serving module in response to monitoring a synchronization event of the first business information.

In some embodiments, the synchronization event of the first business information comprises at least one of: the user creating, updating, or deleting the first business information, the user creating, updating, or deleting the associated information of the first business information, or the user updating a preset state of the first business information.

In some embodiments, it is possible to, by calling a preset interface for newly adding a record in the target online document, newly add a corresponding record in the target online document on the basis of the first service request.

In this way, according to one or more embodiments of the present disclosure, when a first business synchronization request comes from an online document serving module, a business synchronization type of the first business synchronization request is determined, and first business information in a first business information serving module is synchronized on the basis of the determined business synchronization type, and when the first business synchronization request comes from the first business information serving module, a record about the first business information in a target online document in the online document serving module is synchronized on the basis of the first business synchronization request, thereby achieving bidirectional communication between the online document serving module and the first business information serving module, such that the first business information can be synchronized between the online document serving module and the first business information serving module, and the user can perform visualization management on the first business information using an online document, improving the processing efficiency of the first business information.

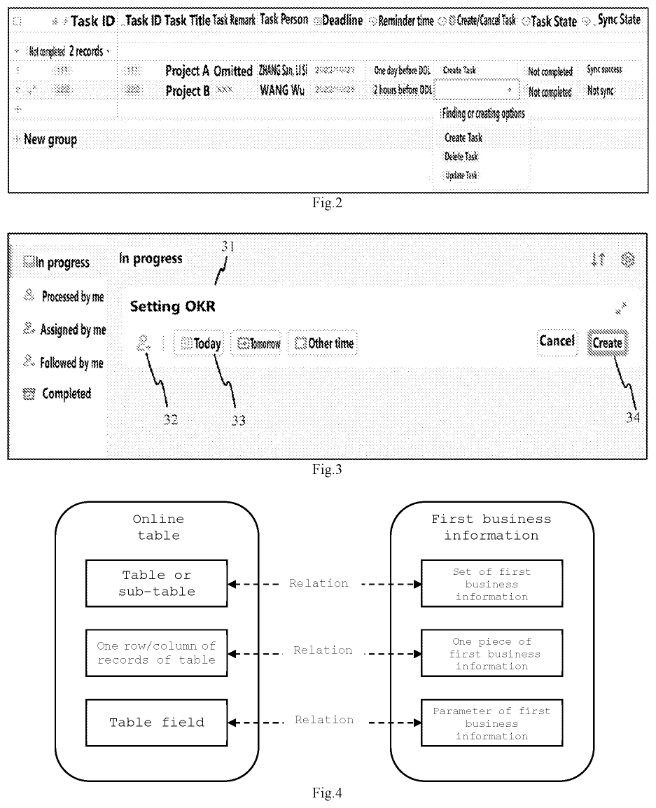

The following description is made by taking an example that the first business information is task information and the target online document is an online table; referring to FIG. 2, in cells of a first row of the online table, a plurality of task fields are sequentially provided, including, for example, task fields such as “Task ID”, “Task Title”, “Task Remark”, “Task Person”, “Deadline”, “Reminder Time”, “Create/Cancel Task”, “Task State”, “Synchronization State”, and the like, and the user may enter corresponding data in each task field as corresponding task data. Referring to FIG. 2 further, in the task field “Create/Cancel Task”, one or more options (e.g., “Create Task,” “Delete Task,” “Update Task”) are also provided for selection by the user, and when the user selects the “Create Task” option, an online table service may be triggered to send a first business synchronization request for creating corresponding task information (with a task subject of “Project B”), to create a corresponding task on the basis of a corresponding record in the table; when the user selects the “Delete Task” option, the online table service may be triggered to send a first business synchronization request for deleting corresponding task information (with a task subject of “Project B”), to delete a corresponding task; and when the user selects the “Update Task” option, the online table service may be triggered to send a first business synchronization request for updating corresponding task information (with a task subject of “Project B”), to update a corresponding task on the basis of a corresponding record in the table.

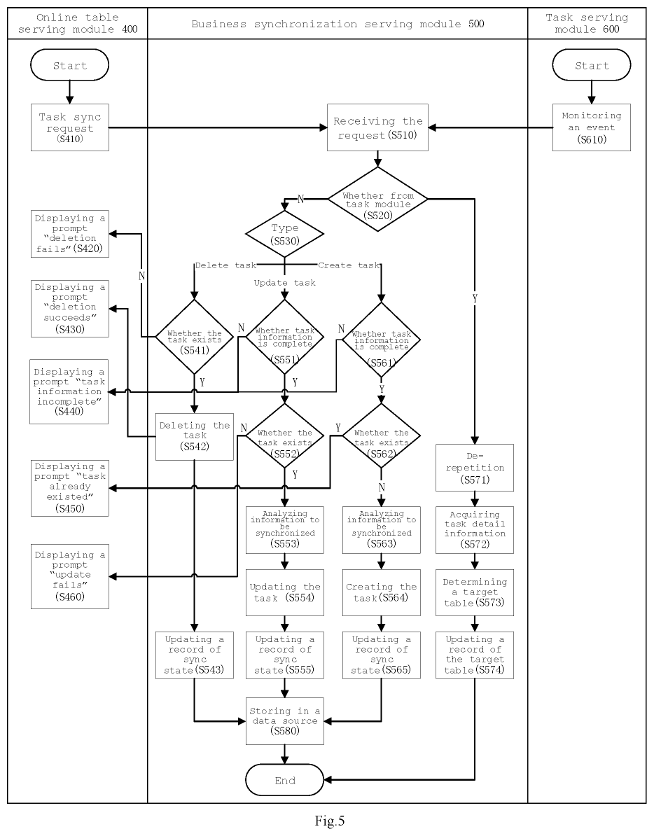

FIG. 3 illustrates a schematic diagram of a task information display page provided by a first business information serving module; referring to FIG. 3, a user may, in an editing box 31 provided in a task information display interface, enter a task subject or task content “Setting Objectives and Key Results (OKR)”, add a task person (e.g., an executor, follower, supervisor, responsible person, etc. of the task) by triggering a control 32, determine an deadline of the task by triggering a control 33, and finally create, in the first business information serving module, corresponding task information on the basis of the task information (e.g., task subject, person, time, etc.) entered or determined by the user in the interface by triggering a control 34. And, after the user triggers the control 34, the first business information serving module sends a first business synchronization request for updating a record of the task information in the target online document.

In some embodiments, the target online document comprises an online table associated with a set of the first business information, a field of the online table being associated with a parameter of the first business information, and one row or column of records in the online table being associated with one piece of first business information.

FIG. 4 illustrates a schematic diagram of a business abstraction relationship between an online table and first business information. Referring to FIG. 4, the online table or a sub-table therein may correspond to a set of the first business information, that is, correspond to more than one piece of different first business information; each field in the online table may correspond to one parameter (e.g., a parameter such as subject, content, person, time, etc.) of the first business information; and one row or column of records in the online table may correspond to one piece of first business information.

According to one or more embodiments of the present disclosure, by means of bidirectional communication between the online table and the first business information, the online table is associated with a set of the first business information, a field of the online table is associated with a parameter of the first business information, and one row or column of records in the online table is associated with one piece of first business information, such that the user can conveniently create, summarize, manage, and update a plurality of tasks through the online table, and meanwhile, requirements of the user for creation, distribution, and management of the tasks, as well as task list visualization can be met, thereby improving processing efficiency of the user for the tasks.

In some embodiments, the step S160 further comprises:
step A11: determining whether the first business information exists;
step A21: if the first business synchronization request is not a request for creating the first business information and the first business information does not exist, returning, to the online document serving module, first prompt information about a request failure; and
step A22: if the first business synchronization request is a request for creating the first business information and the first business information exists, returning, to the online document serving module, second prompt information about a request failure.

In this embodiment, before the first business information is synchronized, it may be further determined whether the first business information to be synchronized exists, and if the first business synchronization request is a request for creating the first business information and the first business information exists, a prompt about a request failure is returned to the online document serving module, such that repeated creation of the same synchronization request can be avoided, and repeated creation of the first business information is avoided; if the first business synchronization request is not a request for creating the first business information and the first business information does not exist, a prompt about a request failure is returned to the online document serving module, such that a synchronization operation such as updating or deleting operation or the like on nonexistent first business information can be avoided, to prevent a program running error.

Exemplarily, the first prompt information may be “request fails”, “first business information does not exist”, or the like, and the second prompt information may be “request fails”, “first business information has already existed”, or the like, but this disclosure is not limited thereto.

In some embodiments, if the first business synchronization request is not a request for creating the first business information and the first business information exists, a subsequent synchronization operation may be further performed; if the first business synchronization request is a request for creating the first business information and the first business information does not exist, a subsequent synchronization operation may be further performed.

In some embodiments, the step S160 further comprises:
step B11: if the first business synchronization request comprises a request for creating or updating the first business information, determining whether content of the first business information to be created or updated meets a first preset condition; and
step B12: if the first preset condition is not met, returning, to the online document serving module, third prompt information about a request failure.

The first preset condition is used for measuring whether the content of the first business information to be created or updated meets the preset requirement. Exemplarily, the first preset condition includes that the content of the first business information should be complete, for example, it should include one or more preset types of information, so that if the first business information to be created or updated includes the one or more preset types of information, it is considered that the first preset condition is met.

Exemplarily, the third prompt information may be “request fails”, “first business information does not meet the condition”, “first business information is incomplete”, or the like, but this disclosure is not limited thereto.

In some embodiments, if the content of the first business information to be created or updated meets the first preset condition, a subsequent synchronization operation may be further performed.

In some embodiments, the step S160 further comprises:
step C11: if the first business synchronization request comprises a request for creating or updating the first business information, creating a reminder time on the basis of the first business information to be created or updated, such that the first business information serving module sends preset reminder information to a target user at the reminder time.

The step C11 may include creating a new reminder time or updating (deleting and creating) an existing reminder time. In a specific implementation, the reminder time may be determined on the basis of the first business information to be created or updated, and the reminder time may be created on the basis of a preset interface for creating the reminder time, but this disclosure is not limited thereto.

In some embodiments, the step S160 further comprises:
step D11: after the synchronization of the first business information is completed, updating a record about a synchronization state of the first business synchronization request in the target online document.

In some embodiments, the target online document has a preset field for indicating the synchronization state of the first business synchronization request, such that after the synchronization of the first business information is completed, the record about the synchronization state of the first business synchronization request may be updated in the preset field. Exemplarily, the record of the updated synchronization state may be “synchronized successfully”, but this disclosure is not limited thereto.

In this embodiment, after the synchronization of the first business information is completed, the record about the synchronization state of the first business synchronization request in the target online document is updated, which makes it convenient for a user of the target online document to know the synchronization state of the first business synchronization request, and makes it convenient for the user to perform subsequent management on the first business information on the basis of the target online table.

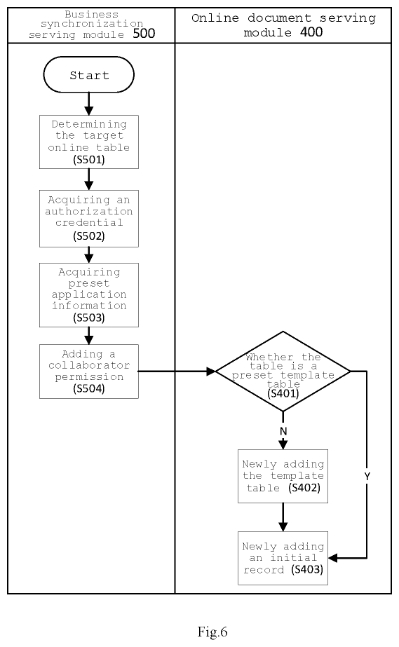

FIG. 5 illustrates a schematic architecture diagram of an information synchronization processing system according to an embodiment of the present disclosure. Referring to FIG. 5, the information synchronization processing system comprises an online table serving module 400, a business synchronization serving module 500, and a task serving module 600. The business synchronization serving module 500 may be configured to perform the information synchronization processing method according to one or more embodiments of the present disclosure.

In step S410, the online table serving module 400 may, in response to a first preset operation of a user in a target online table, trigger a task synchronization request.

In some embodiments, the task synchronization request may include a unique identification (app_token) of the target online table, an identification (table_ID) of a sub-table in the target online table, a record identification (RecordID), a type information (type) of the task synchronization request, task parameter information, and a field name of a task.

In step S610, the task serving module 600 may, in response to monitoring a task information change event, trigger the task synchronization request.

In step S510, the business synchronization serving module 500 receives the task synchronization request.

In step S520, the business synchronization serving module 500 determines whether the task synchronization request comes from the task serving module 600, and if determining that it does not come from the task serving module 600, performs a branch solution corresponding to step S530; and if determining that it comes from the task serving module 600, performs a branch solution corresponding to step S571.

In step S530, the business synchronization serving module 500 may determine a type of the task synchronization request according to the task type information carried in the task synchronization request, and if determining that the type of the request is for deleting a task, perform a branch solution corresponding to step S541; if determining that the type of the request is for updating a task, perform a branch solution corresponding to step S551; and if determining that the type of the request is for creating a task, perform a branch solution corresponding to step S561.

In step S541, the business synchronization serving module 500 determines whether a task to be synchronized exists, if it exists, performs step S542, and if it does not exist, performs corresponding feedback to the online table serving module 400, such that the online table serving module 400 performs step S420: displaying prompt information about the task deletion failure.

In step S542, the business synchronization serving module 500 may delete the corresponding task information in the task serving module 600 by calling a preset interface. Thereafter, the business synchronization serving module 500 performs corresponding feedback, such that the online table serving module 430 performs step S430: displaying prompt information about the task deletion success.

In step S543, the business synchronization serving module 500 updates, in the target online table, a record about a synchronization state of the task synchronization request to “synchronized successfully” by calling a preset interface.

In step S551, the business synchronization serving module 500 determines whether task information to be updated is complete, if it is complete, performs step S552; and if it is not complete, performs corresponding feedback to the online table serving module 400, such that the online table serving module 400 performs step S440: displaying prompt information about task information incomplete, to prompt the user to complete the task information to be updated.

In step S552, the business synchronization serving module 500 determines whether the updated task exists, if it exists, performs step S553; and if it does not exist, performs corresponding feedback to the online table serving module 400, such that the online table serving module 400 performs step S460: displaying prompt information about task update failure, to prompt the user not to update the nonexistent task.

In step S553, the business synchronization serving module 500 analyzes task information to be synchronized. In some embodiments, on the basis of fields in the target online document, records to be synchronized that respectively correspond to the respective fields may be retrieved and determined, to determine to which fields the records to be synchronized should be updated, preventing record update confusion (e.g., updating to a wrong field).

In step S554, the business synchronization serving module 500 updates the corresponding task in the task serving module 600 by calling a preset interface on the basis of the analyzed information.

In step S555, the business synchronization serving module 500 updates, in the target online table, a record about a synchronization state of the task synchronization request to “synchronized successfully” by calling a preset interface.

In step S561, the business synchronization serving module 500 determines whether task information to be created is complete, if it is complete, performs step S562; and if it is not complete, performs corresponding feedback to the online table serving module 400, such that the online table serving module 400 performs step S440: displaying prompt information about task information incomplete, to prompt the user to complete the task information of the task to be created.

In step S562, the business synchronization serving module 500 determines whether the created task exists (i.e., determines whether it belongs to repeated creation), if it does not exist, performs step S563; and if it exists, performs corresponding feedback to the online table serving module 400, such that the online table serving module 400 performs step S440: displaying prompt information about the task already existence, to prompt the user not to create the already existed task.

In step S563, the business synchronization serving module 500 analyzes task information to be synchronized. In some embodiments, on the basis of fields in the target online document, records to be synchronized that respectively correspond to the fields may be retrieved and determined, to determine to which fields the records to be synchronized should be updated, preventing record update confusion.

In step S564, the business synchronization serving module 500 creates the corresponding task in the task serving module 600 by calling a preset interface on the basis of the analyzed information.

In step S565, the business synchronization serving module 500 updates, in the target online table, a record about a synchronization state of the task synchronization request to “synchronized successfully” by calling a preset interface.

In step S580, preset synchronization information is stored in a data source. Exemplarily, the preset synchronization information may include a unique identification (app_token) of the target online table, an identification (table_ID) of a sub-table in the target online table, a record identification (RecordID), a task identification (task_ID), an event identification, and the like.

In step S571, the business synchronization serving module 500 may perform de-repetition on a repeated synchronization request triggered by a task information change event on the basis of an event identification carried in the business synchronization request, to prevent repeated processing of the synchronization request corresponding to the same task information change event.

In step S572, the business synchronization serving module 500 may acquire task detail information of the corresponding task on the basis of a task identification carried in the business synchronization request.

In step S573, the business synchronization serving module 500 may determine a target online table to be updated.

In step S574, the business synchronization serving module 500 may update a record of the determined target online table on the basis of the acquired task detail information.

In some embodiments, the target online table further includes a first sub-table specifically used for recording a task change, such that the business synchronization serving module 500 may update a record in the first sub-table.

It should be noted that, for the embodiments of the system, since they basically correspond to the method embodiments, reference can be made to the partial description of the method embodiments for relevant points, which will be not repeated herein.

In some embodiments, the method 100 further comprises:
step S101: pre-acquiring an address of the target online document entered by a user; and step S102: determining the target online document on the basis of the address of the target online document.

In this embodiment, a target online document to be synchronized may be determined by a link of the target online document provided by the user. Exemplarily, the address of the target online document may be a link of the target online document.

In some embodiments, the method 100 further comprises:
step S103: acquiring a collaborator permission of the target online document, the collaborator permission comprising a permission for reading and editing the content of the target online document.

In this embodiment, by acquiring the collaborator permission of the target online document, the content of the target online document can be read and edited, such that the record of the target online document can be conveniently acquired to synchronize the first business information, and the record about the first business information in the target online document is updated on the basis of the synchronization request of the first business information serving module.

In a specific implementation, an authorization credential of the online document serving module may be acquired, to acquire the collaborator permission of the target online document. For example, the collaborator permission may be acquired on the basis of the authorization credential of the online document serving module entered by the user.

In some embodiments, the step S103 comprises:
step E11: acquiring preset application identity information; and
step E12: configuring, for a preset application corresponding to the preset application identity information, the collaborator permission of the target online document.

The preset application may be an execution subject for executing the information synchronization processing method provided in one or more embodiments of the present disclosure or an application controlled by the execution subject. In this embodiment, by acquiring the preset application identity information, the collaborator permission of the target online document is configured for the corresponding preset application, such that the content of the target online document can be read or edited by the preset application.

In some embodiments, it is possible to update a record about the first business information in the target online document by the preset application, or update a record about a synchronization state of the first business synchronization request in the target online document by the preset application. Exemplarily, since the preset application has the collaborator permission of the target online document, it is possible to update, by calling a preset interface by the preset application, the record about the first business information and the record about the synchronization state of the first business synchronization request in the target online document.

In some embodiments, it is possible to preset a template document for synchronizing the first business information, and determine whether the target online document corresponding to the address of the target online document entered by the user is the template document, and if determining that the target online document is not the template document, newly add the template document in the target online document. In this embodiment, when it is determined that the target online document provided by the user for synchronizing the first business information is not the preset template document, the preset template document may be newly added in the target online document, so as to synchronize the first business information. Compared with a user-defined document, the fields and format preset in the template document preset by the system better meet the requirement of the system for synchronizing the first business information, such that it is possible to generate the corresponding first business information on the basis of content recorded by the newly added template document in the target online document, and perform subsequent management on the first business information by the newly added template document. It should be noted that the execution subject of this embodiment may be the online document serving module, but this disclosure is not limited thereto.

In some specific embodiments, the content of the template document may include the content of the target online table shown in FIG. 2, but this disclosure is not limited thereto.

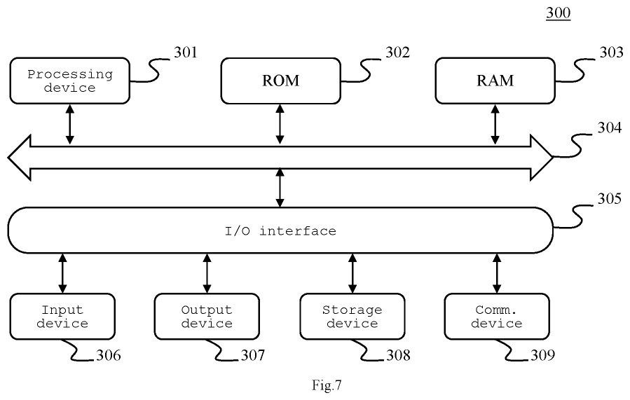

FIG. 6 illustrates a schematic architecture diagram of an information synchronization processing system according to an embodiment of the present disclosure. Referring to FIG. 6, the information synchronization processing system comprises an online table serving module 400 and a business synchronization serving module 500.

In step S501, the business synchronization serving module 500 may, on the basis of an address of a target online table pre-entered by a user, analyze a unique identification (e.g., token) of the target online table, to determine the target online table.

In step S502, the business synchronization serving module 500 may acquire an authorization credential of the online document serving module 400.

In step S503, the business synchronization serving module 500 may acquire preset application information entered by the user, for example, a unique identification of a preset application, such as an ID (APP ID) and key (APP secret) of the preset application. Exemplarily, the preset application may be a robot (BOT) in the business synchronization serving module 500.

In step S504, a collaborator permission of the target online table may be added for the preset application on the basis of the acquired authorization credential, such that the preset application can read and edit the target online table.

In step S401, the online document serving module 400 may determine whether the target online table is a preset template table; if the target online table is the template table, perform step S403; and if the target online table is not the template table, perform step S402.

In step S402, the template table is newly added in the target online table.

In step S403, a preset initial record is newly added in the template table or the template table in the target table. In some embodiments, the initial record may be preset task parameters, such as “Task Setting”, “Task Title”, “Reminder time”, “Task Executor”, “Task Follower”, “Repetition rule”, “Task Remark”, “Jump Link”, or the like.

It should be understood that although it is shown in FIG. 6 that the steps S401-S403 are performed by the online document serving module 400, the present disclosure is not limited thereto. In some embodiments, the steps S401-S403 shown in FIG. 6 may be performed by the business synchronization serving module 500, or performed by the business synchronization serving module 500 instructing the online document serving module 400.

According to one or more embodiments of the present disclosure, a template document is added in the target online document, and a collaborator permission of the target online document is acquired, such that the template document and its internal relevant parameters can be automatically configured for the target online document provided by a user, to complete initialization of the target online document, so as to perform subsequent synchronization processing on the basis of the target online document, for example, the information synchronization processing method described in the foregoing embodiments.

In some embodiments, the task field in the template table includes one or more of: a field for indicating task title, a field for indicating task ID, a field for indicating task content, a field for indicating person associated with the task, a field for indicating task time information, a field for indicating task reminder manner, a field for indicating creating, cancelling, or updating a task, a field for indicating a completion state of the task, and a field for indicating synchronization state of the task.

The person associated with the task includes, but is not limited to a creator, executor, follower, supervisor, etc. of the task; the task time information includes, but is not limited to, a creation time of the task and a deadline of the task; the task reminder manner includes, but is not limited to, reminder time, reminder period, or reminder rule of the task; the task state includes, but is not limited to, a not-completed-state of the task, an already-completed-state of the task; and the task synchronization state is used for reflecting whether the task has been successfully created, or whether the task has been synchronized to the person associated with the task, or whether the task is synchronized into a preset task server.

In some embodiments, the template table may be a multi-dimensional table through which task information is managed. In some embodiments, a row or column in the multi-dimensional table is used for storing the task information. In some embodiments, the multidimensional table can record different types of data, including a multimedia file such as an image and video, and in the multidimensional table, row storage or column storage may be used, wherein task information of one task is stored in one row or column, for example, each row in FIG. 2 is used for storing task information of different tasks, respectively.

In some embodiments, the online table is a database table. Different from a conventional excel or spreadsheet, each column of data in the database table is configured with one data type, and only data corresponding to the data type can be entered in a cell of the column; and each cell, when created, is assigned a data type corresponding to a field in a header row of each column of cell data.

Accordingly, according to an embodiment of the present disclosure, there is provided an information synchronization processing apparatus, comprising:
a request receiving unit configured to receive a first business synchronization request;
a request determination unit configured to determine a serving module from which the first business synchronization request comes; and
a business synchronization unit configured to perform at least one of the following synchronization operations: if the first business synchronization request comes from an online document serving module, determining a business synchronization type of the first business synchronization request, and synchronizing first business information in a first business information serving module on the basis of the determined business synchronization type, or if the first business synchronization request comes from the first business information serving module, synchronizing a record about the first business information in a target online document in the online document serving module on the basis of the first business synchronization request.

In some embodiments, the first business information comprises task information or an instant messaging message.

In some embodiments, the first business information serving module comprises an instant messaging serving module.

In some embodiments, the first business synchronization request comprises at least one of: a request for creating, updating, or deleting the first business information in another serving module other than the serving module sending the first business synchronization request, a request for creating, updating, or deleting associated information of the first business information in another serving module other than the serving module sending the first business synchronization request, or a request for updating a preset state of the first business information in another serving module other than the serving module sending the first business synchronization request.

In some embodiments, the first business synchronization request is triggered by the online document serving module in response to a first preset operation of a user in the target online document; or, the first business synchronization request is triggered by the first business information serving module in response to monitoring a synchronization event of the first business information.

In some embodiments, the first preset operation of the user in the online document comprises: entering, by the user, a preset type of data in a first preset task field in the online document.

In some embodiments, the synchronization event of the first business information comprises at least one of: the user creating, updating, or deleting the first business information, the user creating, updating, or deleting the associated information of the first business information, or the user updating the preset state of the first business information.

In some embodiments, the associated information comprises comment information.

In some embodiments, if the first business information is the task information, the preset state of the first business information comprises a state of whether a task is completed.

In some embodiments, the target online document comprises an online table associated with a set of the first business information, a field of the online table being associated with a parameter of the first business information, and one row or column of records in the online table being associated with one piece of first business information.

In some embodiments, the business synchronization unit comprises:
a business existence determination unit configured to determine whether the first business information exists, and if the first business synchronization request is not a request for creating the first business information and the first business information does not exist, return, to the online document serving module, first prompt information about a request failure, or if the first business synchronization request is a request for creating the first business information and the first business information exists, return, to the online document serving module, second prompt information about a request failure.

In some embodiments, the business synchronization unit comprises:
a business completeness determination unit configured to, if the first business synchronization request comprises a request for creating or updating the first business information, determine whether content of the first business information to be created or updated meets a first preset condition; and if the first preset condition is not met, return, to the online document serving module, third prompt information about a request failure.

In some embodiments, the business synchronization unit comprises:
a reminder creation unit configured to, if the first business synchronization request comprises a request for creating or updating the first business information, create a reminder time on the basis of the first business information to be created or updated, such that the first business information serving module sends preset reminder information to a target user at the reminder time.

In some embodiments, the business synchronization unit comprises:
a synchronization recording unit configured to, after the synchronization of the first business information is completed, update a record about a synchronization state of the first business synchronization request in the target online document.

In some embodiments, the information synchronization processing apparatus comprises:
a document determination unit configured to pre-acquire an address of the target online document entered by the user, and determine the target online document on the basis of the address of the target online document.

In some embodiments, the information synchronization processing apparatus comprises:
a permission acquisition unit configured to acquire a collaborator permission of the target online document, the collaborator permission comprising a permission for reading and editing content of the target online document.

In some embodiments, the permission acquisition unit is configured to acquire preset application identity information, and configure, for a preset application corresponding to the preset application identity information, the collaborator permission of the target online document.

In some embodiments, the synchronizing a record about the first business information in a target online document in the online document serving module, comprises: updating the record about the first business information in the target online document by the preset application.

In some embodiments, the updating a record about a synchronization state of the first business synchronization request in the target online document comprises: updating the record about the synchronization state of the first business synchronization request in the target online document by a preset application, the preset application being pre-configured with a collaborator permission of the target online document.

In some embodiments, the information synchronization processing apparatus comprises:
a template initialization unit configured to preset a template document for synchronizing the first business information; determine whether the target online document is the template document; and if determining that the target online document is not the template document, newly add the template document in the target online document. For the embodiments of the apparatus, reference can be made to the partial description of the method embodiments for relevant points, since they substantially correspond to the method embodiments. The apparatus embodiments described above are merely illustrative, wherein modules illustrated as separate modules may or may not be separate. Some or all of the modules may be selected according to actual needs to achieve the purpose of the solution of this embodiment. One of ordinary skill in the art can understand and implement them without paying creative labor.

For the embodiments of the system, since they substantially correspond to the method embodiments, reference can be made to the partial description of the method embodiments for relevant points.

Accordingly, according to one or more embodiments of the present disclosure, there is provided an electronic device, comprising:
at least one memory and at least one processor,
wherein the memory is configured to store program codes, and the processor is configured to call the program codes stored in the memory to cause the electronic device perform the information synchronization processing method according to one or more embodiments of the present disclosure.

Accordingly, according to one or more embodiments of the present disclosure, there is provided a non-transitory computer storage medium having stored thereon program codes which are executable by a computer device to cause the computer device to perform the information synchronization processing method according to one or more embodiments of the present disclosure.

Accordingly, according to one or more embodiments of the present disclosure, there is provided a computer program which, when executed by a processor, implements the information synchronization processing method according to one or more embodiments of the present disclosure.

Hereinafter, referring to FIG. 7, it illustrates a schematic structural diagram of an electronic device (e.g., a terminal device or server) 300 suitable for implementing an embodiment of the present disclosure. The terminal device in the embodiment of the present disclosure may include, but is not limited to, a mobile terminal such as a mobile phone, a laptop, a digital broadcast receiver, a PDA (Personal Digital Assistant), a PAD (tablet), a PMP (Portable Multimedia Player), a vehicle-mounted terminal (e.g., a vehicle-mounted navigation terminal), and the like, and a fixed terminal such as a digital TV, a desktop computer, and the like. The electronic device shown in FIG. 7 is only an example, and should not bring any limitation to the functions and the scope of use of the embodiments of the present disclosure.

As shown in FIG. 7, the electronic device 300 may comprise a processing device (e.g., a central processing unit, a graphics processing unit, etc.) 301 that may perform various appropriate actions and processes according to a program stored in a read-only memory (ROM) 302 or a program loaded from a storage device 308 into a random access memory (RAM) 303. In the RAM 303, various programs and data required for the operation of the electronic device 300 are also stored. The processing device 301, the ROM 302, and the RAM 303 are connected to each other via a bus 304. An input/output (I/O) interface 305 is also connected to the bus 304.

Generally, the following device may be connected to the I/O interface 305: an input device 306 including, for example, a touch screen, touch pad, keyboard, mouse, camera, microphone, accelerometer, gyroscope, etc.; an output device 307 including, for example, a liquid crystal display (LCD), speaker, vibrator, etc.; the storage device 308 including, for example, a magnetic tape, hard disk, etc.; and a communication device 309. The communication device 309 may allow the electronic device 300 to communicate with other devices, wirelessly or by wire, to exchange data. While FIG. 7 illustrates the electronic device 300 having various device, it should be understood that not all illustrated device are required to be implemented or provided. More or fewer device may be alternatively implemented or provided.

In particular, according to the embodiments of the present disclosure, the processes described above with reference to the flow diagrams may be implemented as a computer software program. For example, an embodiment of the present disclosure comprises a computer program product comprising a computer program carried on a computer-readable medium, the computer program containing program codes for performing the method illustrated by the flow diagrams. In such an embodiment, the computer program may be downloaded and installed from a network via the communication device 309, or installed from the storage device 308, or installed from the ROM 302. The computer program, when executed by the processing device 301, performs the above functions defined in the method of the embodiment of the present disclosure.

It should be noted that the above computer-readable medium of the present disclosure may be a computer-readable signal medium or a computer-readable storage medium or any combination of the above two. The computer-readable storage medium may be, for example, but is not limited to, an electronic, magnetic, optical, electromagnetic, infrared, or semiconductor system, apparatus, or device, or any combination of the foregoing. More specific examples of the computer-readable storage medium may include, but are not limited to: an electrical connection having one or more wires, a portable computer diskette, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the foregoing. In the present disclosure, the computer-readable storage medium may be any tangible medium containing or storing a program, wherein the program can be used by or in conjunction with an instruction execution system, apparatus, or device. However, in the present disclosure, the computer-readable signal medium may include a data signal propagated in baseband or as part of a carrier wave, in which computer-readable program codes are carried. Such a propagated data signal may take a variety of forms, including, but not limited to, an electromagnetic signal, optical signal, or any suitable combination of the forgoing. The computer-readable signal medium may also be any computer-readable medium other than the computer-readable storage medium, wherein the computer-readable signal medium can send, propagate, or transmit a program for use by or in conjunction with an instruction execution system, apparatus, or device. The program codes contained on the computer-readable medium may be transmitted using any appropriate medium, including but not limited to: a wire, an optical cable, RF (Radio Frequency), etc., or any suitable combination of the foregoing.

In some implementations, a client and a server may communicate using any currently known or future developed network protocol, such as HTTP (HyperText Transfer Protocol), and may be interconnected with any form or medium of digital data communication (e.g., a communication network). Examples of the communication network include a local area network (“LAN”), a wide area network (“WAN”), an internet (e.g., the Internet), and a peer-to-peer network (e.g., an ad hoc peer-to-peer network), as well as any currently known or future developed network.

The above computer-readable medium may be contained in the above electronic device; or may exist separately without being assembled into the electronic device.

The above computer-readable medium has one or more programs carried thereon, wherein the above one or more programs, when executed by the electronic device, cause the electronic device to perform the method of the present disclosure described above.

Computer program codes for performing the operation of the present disclosure may be written in one or more programming languages or a combination thereof, wherein the above programming language includes but is not limited to an object-oriented programming language such as Java, Smalltalk, and C++, and also includes a conventional procedural programming language, such as a “C” language or a similar programming language. The program codes may be executed entirely on a user's computer, partly on a user's computer, as a stand-alone software package, partly on a user's computer and partly on a remote computer, or entirely on a remote computer or server. In a scenario where a remote computer is involved, the remote computer may be connected to a user's computer through any type of network, including a local area network (LAN) or a wide area network (WAN), or may be connected to an external computer (for example, through the Internet using an Internet service provider).

The flow diagrams and block diagrams in the drawings illustrate the possibly implemented architecture, functions, and operations of the system, method and computer program product according to various embodiments of the present disclosure. In this regard, each block in the flow diagrams or block diagrams may represent a module, program segment, or part of code, which includes one or more executable instructions for implementing a specified logical function. It should also be noted that, in some alternative implementations, functions noted in blocks may occur in a different order from those noted in the drawings. For example, two blocks shown in succession may, in fact, be executed substantially concurrently, or they may sometimes be executed in a reverse order, which depends upon the functions involved. It will also be noted that each block in the block diagrams and/or flow diagrams, and a combination of the blocks in the block diagrams and/or flow diagrams, can be implemented by a special-purpose hardware-based system that performs specified functions or operations, or by a combination of special-purpose hardware and computer instructions.

The involved units described in the embodiments of the present disclosure may be implemented by software or hardware. The name of the unit does not, in some cases, constitute a limitation on the unit itself.

The functions described above herein may be executed, at least partially, by one or more hardware logic components. For example, without limitation, a hardware logic component of an exemplary type that may be used comprises: a field programmable gate array (FPGA), an application specific integrated circuit (ASIC), an application specific standard parts (ASSP), a system on chip (SOC), a complex programmable logic device (CPLD), and the like.

In the context of this disclosure, a machine-readable medium may be a tangible medium, which can contain or store a program for use by or in conjunction with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination of the foregoing. More specific examples of the machine-readable storage medium include an electrical connection based on one or more wires, a portable computer diskette, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the foregoing.

According to one or more embodiments of the present disclosure, there is provided an information synchronization processing method, comprising: receiving a first business synchronization request; determining a serving module from which the first business synchronization request comes; and at least one of the following synchronization steps: if the first business synchronization request comes from an online document serving module, determining a business synchronization type of the first business synchronization request, and synchronizing first business information in a first business information serving module on the basis of the determined business synchronization type; or if the first business synchronization request comes from the first business information serving module, synchronizing a record about the first business information in a target online document in the online document serving module on the basis of the first business synchronization request.

According to one or more embodiments of the present disclosure, the first business information comprises task information or an instant messaging message.

According to one or more embodiments of the present disclosure, the first business information serving module comprises an instant messaging serving module.

According to one or more embodiments of the present disclosure, the first business synchronization request comprises at least one of: a request for creating, updating, or deleting the first business information in another serving module other than the serving module sending the first business synchronization request, a request for creating, updating, or deleting associated information of the first business information in another serving module other than the serving module sending the first business synchronization request, or a request for updating a preset state of the first business information in another serving module other than the serving module sending the first business synchronization request.

According to one or more embodiments of the present disclosure, the first business synchronization request is triggered by the online document serving module in response to a first preset operation of a user in the target online document; or, the first business synchronization request is triggered by the first business information serving module in response to monitoring a synchronization event of the first business information.

According to one or more embodiments of the present disclosure, the first preset operation of the user in the online document comprises: entering, by the user, a preset type of data in a first preset task field in the online document.

According to one or more embodiments of the present disclosure, the synchronization event of the first business information comprises at least one of: the user creating, updating, or deleting the first business information, the user creating, updating, or deleting the associated information of the first business information, or the user updating the preset state of the first business information.

According to one or more embodiments of the present disclosure, the associated information comprises comment information.

According to one or more embodiments of the present disclosure, if the first business information is the task information, the preset state of the first business information comprises a state of whether a task is completed.

According to one or more embodiments of the present disclosure, the target online document comprises an online table associated with a set of the first business information, a field of the online table being associated with a parameter of the first business information, and one row or column of records in the online table being associated with one piece of first business information.

According to one or more embodiments of the present disclosure, the synchronizing first business information on the basis of the determined business synchronization type comprises: determining whether the first business information exists; if the first business synchronization request is not a request for creating the first business information and the first business information does not exist, returning, to the online document serving module, first prompt information about a request failure; or, if the first business synchronization request is a request for creating the first business information and the first business information exists, returning, to the online document serving module, second prompt information about a request failure.

According to one or more embodiments of the present disclosure, the synchronizing first business information on the basis of the determined business synchronization type comprises: if the first business synchronization request comprises a request for creating or updating the first business information, determining whether content of the first business information to be created or updated meets a first preset condition; and if the first preset condition is not met, returning, to the online document serving module, third prompt information about a request failure.

According to one or more embodiments of the present disclosure, the synchronizing first business information on the basis of the determined business synchronization type comprises: if the first business synchronization request comprises a request for creating or updating the first business information, creating a reminder time on the basis of the first business information to be created or updated, such that the first business information serving module sends preset reminder information to a target user at the reminder time.

According to one or more embodiments of the present disclosure, the synchronizing first business information on the basis of the determined business synchronization type comprises: after the synchronization of the first business information is completed, updating a record about a synchronization state of the first business synchronization request in the target online document.

According to one or more embodiments of the present disclosure, an address of the target online document entered by a user is pre-acquired; and the target online document is determined based on the address of the target online document.

According to one or more embodiments of the present disclosure, a collaborator permission of the target online document is acquired, the collaborator permission comprising a permission for reading and editing content of the target online document.

According to one or more embodiments of the present disclosure, the acquiring a collaborator permission of the target online document comprises: acquiring preset application identity information; and configuring, for a preset application corresponding to the preset application identity information, the collaborator permission of the target online document.

According to one or more embodiments of the present disclosure, the synchronizing a record about the first business information in a target online document in the online document serving module comprises: updating the record about the first business information in the target online document by the preset application.

According to one or more embodiments of the present disclosure, the updating a record about a synchronization state of the first business synchronization request in the target online document comprises: updating the record about the synchronization state of the first business synchronization request in the target online document by a preset application, the preset application being pre-configured with a collaborator permission of the target online document.

According to one or more embodiments of the present disclosure, a template document for synchronizing the first business information is preset; it is determined whether the target online document is the template document; and if it is determined that the target online document is not the template document, the template document is newly added in the target online document.

According to one or more embodiments of the present disclosure, there is provided an information synchronization processing system, comprising: an online document serving module configured to, in response to a first preset operation of a user in a target online document, send a first business synchronization request to a business synchronization serving module; a first business information serving module configured to, in response to monitoring a synchronization event of first business information, send the first business synchronization request to the business synchronization serving module; and the business synchronization serving module configured to, in response to receiving the first business synchronization request, perform the following operations: determining a serving module from which the first business synchronization request comes; and at least one of the following synchronization operations: if the first business synchronization request comes from the online document serving module, determining a business synchronization type of the first business synchronization request, and synchronizing the first business information in the first business information serving module on the basis of the determined business synchronization type; or, if the first business synchronization request comes from the first business information serving module, synchronizing a record about the first business information in the target online document in the online document serving module on the basis of the first business synchronization request.

According to one or more embodiments of the present disclosure, there is provided an information synchronization processing apparatus, comprising: a request receiving unit configured to receive a first business synchronization request; a request determination unit configured to determine a serving module from which the first business synchronization request comes; and a business synchronization unit configured to perform at least one of the following synchronization operations: if the first business synchronization request comes from an online document serving module, determining a business synchronization type of the first business synchronization request, and synchronizing first business information in a first business information serving module on the basis of the determined business synchronization type, or if the first business synchronization request comes from the first business information serving module, synchronizing a record about the first business information in a target online document in the online document serving module on the basis of the first business synchronization request.

According to one or more embodiments of the present disclosure, there is provided an electronic device, comprising: at least one memory and at least one processor, wherein the memory is configured to store program codes, and the processor is configured to call the program codes stored in the memory to cause the electronic device to perform the information synchronization processing method according to one or more embodiments of the present disclosure.

According to one or more embodiments of the present disclosure, there is provided a non-transitory computer storage medium having stored thereon program codes which, when executed by a computer device, cause the computer device to perform the information synchronization processing method according to one or more embodiments of the present disclosure.

According to one or more embodiments of the present disclosure, there is provided a computer program which, when executed by a processor, implements the information synchronization processing method according to one or more embodiments of the present disclosure.

The foregoing description is only illustration of the preferred embodiments of the present disclosure and the technical principles employed. It should be appreciated by those skilled in the art that the disclosure scope involved in the present disclosure is not limited to the technical solutions formed by specific combinations of the above technical features, but also encompasses other technical solutions formed by arbitrary combinations of the above technical features or equivalent features thereof without departing from the above disclosed concepts, for example, a technical solution formed by performing mutual replacement between the above features and technical features having similar functions disclosed in the present disclosure (but not limited to these features).

Furthermore, while operations are depicted in a specific order, this should not be understood as requiring that these operations be performed in the specific order shown or in a sequential order. Under certain circumstances, multitasking and parallel processing might be advantageous. Similarly, while several specific implementation details are included in the above discussion, these should not be construed as limitations on the scope of the present disclosure. Certain features that are described in the context of separate embodiments may also be implemented in combination in a single embodiment. Conversely, various features that are described in the context of a single embodiment may also be implemented in multiple embodiments separately or in any suitable sub-combination.

Although the subject matter has been described in language specific to structural features and/or method logical actions, it should be understood that the subject matter defined in the attached claims is not necessarily limited to the specific features or actions described above. Rather, the specific features and actions described above are only example forms of implementing the claims.

1. An information synchronization processing method, comprising:
receiving a first business synchronization request;
determining a serving module from which the first business synchronization request comes; and
at least one of the following synchronization steps:
if the first business synchronization request comes from an online document serving module, determining a business synchronization type of the first business synchronization request, and synchronizing first business information in a first business information serving module on the basis of the determined business synchronization type; or
if the first business synchronization request comes from the first business information serving module, synchronizing a record about the first business information in a target online document in the online document serving module on the basis of the first business synchronization request.

2. The method according to claim 1, wherein the first business information comprises task information or an instant messaging message.

3. The method according to claim 1, wherein the first business information serving module comprises an instant messaging serving module.

4. The method according to claim 1, wherein the first business synchronization request comprises at least one of:
a request for creating, updating, or deleting the first business information in another serving module other than the serving module sending the first business synchronization request,
a request for creating, updating, or deleting associated information of the first business information in another serving module other than the serving module sending the first business synchronization request, or
a request for updating a preset state of the first business information in another serving module other than the serving module sending the first business synchronization request.

5. The method according to claim 1, wherein
the first business synchronization request is triggered by the online document serving module in response to a first preset operation of a user in the target online document, optionally, the first preset operation of the user in the online document comprising: entering, by the user, a preset type of data in a first preset task field in the online document; or
the first business synchronization request is triggered by the first business information serving module in response to monitoring a synchronization event of the first business information, optionally, the synchronization event of the first business information comprising at least one of: the user creating, updating, or deleting the first business information, the user creating, updating, or deleting the associated information of the first business information, or the user updating a preset state of the first business information.

6. (canceled)

7. (canceled)

8. The method according to claim 4, wherein the associated information comprises comment information.

9. The method according to claim 4, wherein if the first business information is task information, the preset state of the first business information comprises a state of whether a task is completed.

10. The method according to claim 1, wherein the target online document comprises an online table associated with a set of the first business information, a field of the online table being associated with a parameter of the first business information, and one row or column of records in the online table being associated with one piece of first business information.

11. The method according to claim 1, wherein the synchronizing first business information on the basis of the determined business synchronization type comprises:
determining whether the first business information exists;
if the first business synchronization request is not a request for creating the first business information and the first business information does not exist, returning, to the online document serving module, first prompt information about a request failure; or
if the first business synchronization request is a request for creating the first business information and the first business information exists, returning, to the online document serving module, second prompt information about a request failure.

12. The method according to claim 1, wherein the synchronizing first business information on the basis of the determined business synchronization type comprises:
if the first business synchronization request comprises a request for creating or updating the first business information, determining whether content of the first business information to be created or updated meets a first preset condition; and
if the first preset condition is not met, returning, to the online document serving module, third prompt information about a request failure.

13. The method according to claim 1, wherein the synchronizing first business information on the basis of the determined business synchronization type comprises:
if the first business synchronization request comprises a request for creating or updating the first business information, creating a reminder time on the basis of the first business information to be created or updated, such that the first business information serving module sends preset reminder information to a target user at the reminder time.

14. The method according to claim 1, wherein the synchronizing first business information on the basis of the determined business synchronization type comprises:
after the synchronization of the first business information is completed, updating a record about a synchronization state of the first business synchronization request in the target online document.

15. The method according to claim 1, further comprising:
pre-acquiring an address of the target online document entered by the user; and
determining the target online document on the basis of the address of the target online document.

16. The method according to claim 15, further comprising:
acquiring a collaborator permission of the target online document, the collaborator permission comprising a permission for reading and editing content of the target online document.

17. The method according to claim 16, wherein the acquiring a collaborator permission of the target online document comprises:
acquiring preset application identity information; and
configuring, for a preset application corresponding to the preset application identity information, the collaborator permission of the target online document.

18. The method according to claim 17, wherein the synchronizing a record about the first business information in a target online document in the online document serving module comprises:
updating the record about the first business information in the target online document by the preset application.

19. The method according to claim 14, wherein the updating a record about a synchronization state of the first business synchronization request in the target online document comprises:
updating the record about the synchronization state of the first business synchronization request in the target online document by a preset application, the preset application being pre-configured with a collaborator permission of the target online document.

20. The method according to claim 15, further comprising:
presetting a template document for synchronizing the first business information;
determining whether the target online document is the template document; and
if determining that the target online document is not the template document, newly adding the template document in the target online document.

21. (canceled)

22. (canceled)

23. An electronic device, comprising:
at least one memory and at least one processor,
wherein the memory is configured to store program codes, and the processor is configured to call the program codes stored by the memory to cause the electronic device to perform the following information synchronization processing operations:
receiving a first business synchronization request;
determining a serving module from which the first business synchronization request comes; and
at least one of the following synchronization steps:
if the first business synchronization request comes from an online document serving module, determining a business synchronization type of the first business synchronization request, and synchronizing first business information in a first business information serving module on the basis of the determined business synchronization type; or
if the first business synchronization request comes from the first business information serving module, synchronizing a record about the first business information in a target online document in the online document serving module on the basis of the first business synchronization request.

24. A non-transitory computer-readable storage medium having stored thereon program codes which, when executed by a computer device, cause the computer device to perform the following information synchronization processing operations:
receiving a first business synchronization request;
determining a serving module from which the first business synchronization request comes; and
at least one of the following synchronization steps:
if the first business synchronization request comes from an online document serving module, determining a business synchronization type of the first business synchronization request, and synchronizing first business information in a first business information serving module on the basis of the determined business synchronization type; or
if the first business synchronization request comes from the first business information serving module, synchronizing a record about the first business information in a target online document in the online document serving module on the basis of the first business synchronization request.

25. (canceled)
